(19) United States
(12) Patent Application Publication
(10) Pub. No.: US 2007/0207735 A1
(43) Pub. Date: Sep. 6, 2007

(54) Mobile communication terminal having wireless communication module and sound output control method thereof

(75) Inventor: Sung-Yeol Jin, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/706,131

(22) Filed: Feb. 14, 2007

(30) Foreign Application Priority Data
Feb. 14, 2006 (KR) P2006-14383

(51) Int. Cl. H04B 7/00

(52) U.S. Cl. 455/41.2; 455/563

(57) ABSTRACT

Provided are a mobile communication terminal and a sound output control method thereof. The mobile communication terminal includes a Bluetooth® module for receiving a command signal for requesting to output a sound stored in the mobile communication terminal from an external Bluetooth® device, and a sound output unit for outputting the sound, if the command signal for requesting to output the sound is received. Accordingly, since a mobile communication terminal can be controlled to ring using Bluetooth® communication, the user can conveniently find the lost mobile communication terminal.

### PRIORITY

This application claims priority under 35 U.S.C. §119 to an application entitled “Mobile Communication Terminal Having Wireless Communication Module and Sound Output Control Method thereof” filed in the Korean Intellectual Property Office on Feb. 14, 2006 and assigned Serial No. 2006-14383, the contents of which are incorporated herein by reference.

### BACKGROUND OF THE INVENTION

1. Field of the Invention

The present invention relates generally to a Bluetooth® hands-free device and a mobile communication terminal, and in particular, to Bluetooth® communication between a Bluetooth® hands-free device and a mobile communication terminal.

2. Description of the Related Art

Recently, mobile communication terminals employing a Bluetooth® module have been developed to support short-distance wireless communication. Bluetooth® is a standard for wireless connecting portable devices, such as portable personal computers (PCs) and wireless terminals, within a short range at a low cost, allowing various digital devices to exchange voice and data using a radio frequency, without a physical cable in communication therebetween.

Hence, Bluetooth® chip equipped modules enabling short-distance wireless data communication with low power consumption have been developed and generally used for various wireless data communication devices. These chips can be produced in a small-sized microchip form, and thus, a voice signal can be transmitted and received through mutual wireless data communication by installing such a wireless data communication device in, for example, a mobile communication terminal, a hands-free device or a headset. Accordingly, such devices using a Bluetooth module have become available on the market. In addition, products for wearing on various positions of the body determined by a user to be most convenient for such handling, have become increasingly available on the market.

A communication process between a mobile communication terminal and a Bluetooth® device will now be described. The Bluetooth® device (hereinafter Bluetooth hands-free (HF)) and the mobile communication terminal must perform connection initialization for Bluetooth® communication. If the Bluetooth® connection initialization is completed, the Bluetooth® HF transmits a command for requesting the mobile communication terminal to perform a specific function.

FIG. 1 illustrates a Bluetooth® communication process for the Bluetooth® hands-free and the mobile communication terminal to perform a voice recognition function. Referring to FIG. 1, reference numeral 10 denotes the Bluetooth® HF, and reference numeral 20 denotes the mobile communication terminal (hereinafter audio gate (AG)).

The HF 10 and the AG 20 can begin connection initialization according to an internal event or a user's input in step 102. If either the HF 10 or the AG 20 begins the connection initialization, the HF 10 and the AG 20 perform a radio frequency communication (RFCOMN) connection establishment procedure in step 104, a service level connection initialization procedure in step 106 and a service level connection establishment procedure in step 108.

If service level connection is established through steps 104 to 108, the AG 20 can receive a command from the HF 10 and perform a relevant job. For example, when the service level connection is established, if a user presses a voice recognition activation key in step 110, the HF 10 transmits a voice recognition activation command to the AG 20 is step 112. Herein, the HF 10 and the AG 20 can use an AT+BVRA command as the voice recognition activation command.

If the AT+BVRA command is received from the HF 10, the AG 20 determines in step 114 whether voice recognition is supported. If it is determined that voice recognition is supported, the AG 20 transmits a voice recognition activation OK signal to the HF 10 in step 116 and sets up an audio connection with the HF 10 in step 118. If it is determined that voice recognition is not supported, the AG 20 informs the HF 10 that voice recognition is not supported, by transmitting an error signal to the HF 10 in step 120.

However, in the communication process between a mobile communication terminal and a Bluetooth® HF using a Bluetooth® module, the command for performing a voice recognition activation function and similar commands exist, but a command used for the Bluetooth® HF to control a specific function of the mobile communication terminal does not exist.

Recently, a coefficient of utilization of Bluetooth® devices separate from mobile communication terminals has increased, along with the occurrence in which a mobile communication terminal is lost while using a Bluetooth® device. Thus, if a mobile communication terminal can be controlled to output sound using a Bluetooth® device, a user can experience the convenience of listening to find a lost mobile communication terminal.

### SUMMARY OF THE INVENTION

An object of the present invention is to substantially solve at least the above problems and/or disadvantages and to provide at least the advantages below. Accordingly, an object of the present invention is to provide a mobile communication terminal having a wireless communication module controlling sound of the mobile communication terminal to be output using Bluetooth® communication, and a sound output control apparatus and method of the mobile communication terminal.

Another object of the present invention is to provide a mobile communication terminal having a wireless communication module controlling sound of the mobile communication terminal to be output using an existing command used between a Bluetooth® hands-free and the mobile communication terminal, and a sound output control apparatus and method of the mobile communication terminal.

According to the present invention, there is provided a mobile communication terminal including a Bluetooth® module for receiving a command signal for requesting to output sound stored in the mobile communication terminal from an external Bluetooth® device; and a sound output unit for outputting the sound, if the command signal for requesting to output the sound is received.

According to the present invention, there is provided a Bluetooth® device including a key input unit having a key for requesting to output a sound of a mobile communication terminal, and a Bluetooth® module for transmitting a command signal for requesting to output the sound of the mobile communication terminal if the key for requesting to output the sound is pressed by a user.

According to the present invention, there is provided a sound output control method of a mobile communication terminal, including receiving a command signal for requesting to output a sound stored in the mobile communication terminal from an external Bluetooth® device, and outputting the sound if the command signal for requesting to output the sound is received.

### BRIEF DESCRIPTION OF THE DRAWINGS

The above and other objects, features and advantages of the present invention will become more apparent from the following detailed description when taken in conjunction with the accompanying drawing in which:

FIG. 1 is a signaling diagram of a conventional Bluetooth® communication process between a Bluetooth® hands-free and a mobile communication terminal;

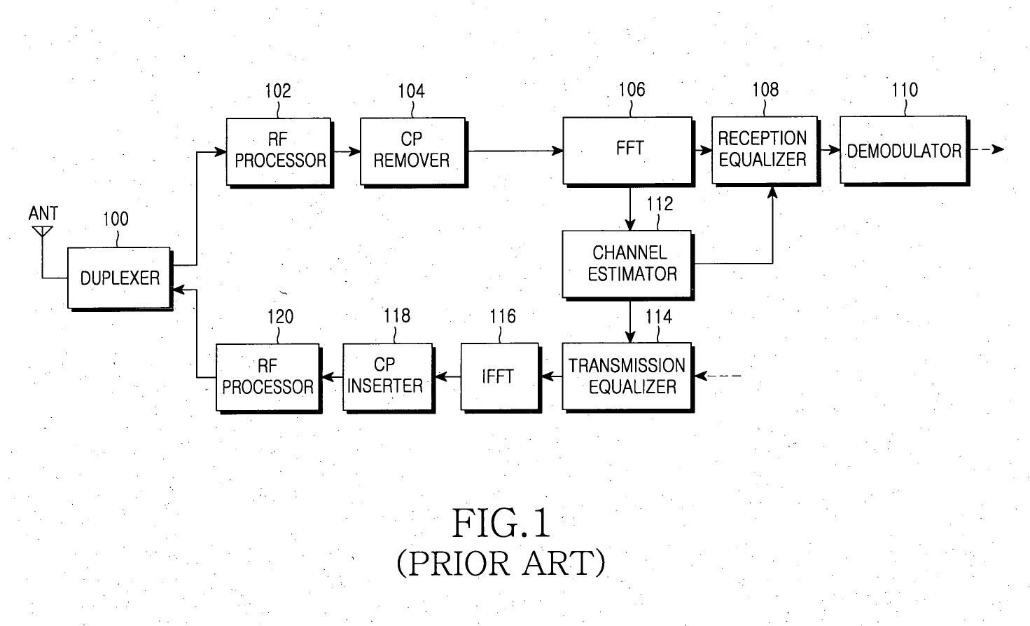

FIG. 2 is a diagram of a Bluetooth® hands-free and a mobile communication terminal according to the present invention;

FIG. 3 is a signaling diagram of a ring control process of a mobile communication terminal having a Bluetooth® module according to a first embodiment of the present invention; and

FIG. 4 is a signaling diagram of a ring control process of a mobile communication terminal having a Bluetooth® module according to a second embodiment of the present invention.

### DETAILED DESCRIPTION OF THE PREFERRED EMBODIMENTS

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail for the sake of clarity and conciseness.

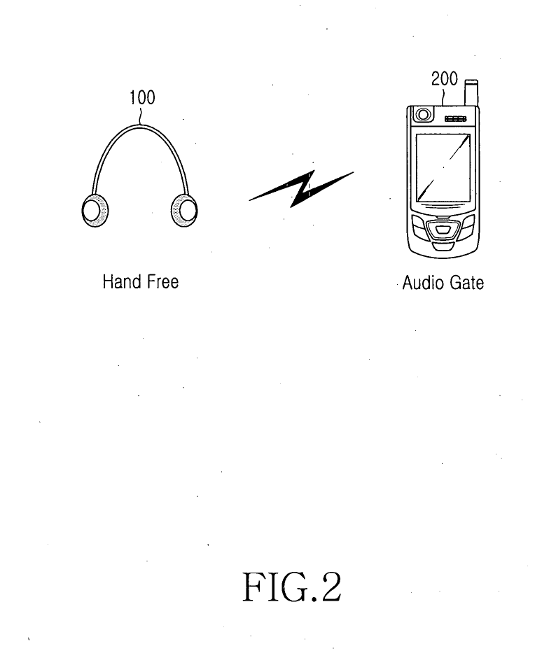

FIG. 2 is a diagram of a Bluetooth® hands-free 100 and a mobile communication terminal 200 according to the present invention.

Referring to FIG. 2, the Bluetooth hands-free (HF) 100 has a key for requesting to output sound (hereinafter ring) of the mobile communication terminal (audio gate (AG)) 200, and if a user presses the ring output request key of the HF 100, the HF 100 transmits a command signal for a ring output control to the AG 200.

Herein, if a service level connection is established between the HF 100 and the AG 200, the HF 100 immediately transmits the command signal for a ring output control to the AG 200, and if the service level connection is not established, the HF 100 transmits the command signal for a ring output control to the AG 200 after establishing the service level connection.

The command signal for a ring output control of the AG 200 can be a signal of transmitting a voice recognition activation signal more than a set amount of times or an AT+CRMP command signal defined in the 3GPP 27.007 specification.

If the command signal for a ring output control of the AG 200 is the signal of transmitting a voice recognition activation signal more than the set amount of times, the ring output request key of the HF 100 can be activated by pressing a voice recognition activation key several times. If the command signal for a ring output control of the AG 200 is the AT+CRMP command signal, the ring output request key of the HF 100 can be realized by a separate key for transmitting the AT+CRMP command signal.

If the command signal for a ring output control is received from the HF 100 in a state where the service level connection is established between the HF 100 and the AG 200, the AG 200 rings.

For example, if the command signal for a ring output control of the AG 200 is implemented by transmitting a voice recognition activation signal more than the set amount of times, when the voice recognition activation signal is received from the HF 100, the AG 200 determines the number of received voice recognition activation signals. If the number of received voice recognition activation signals is greater than a set number, the AG 200 rings.

If the command signal for a ring output control of the AG 200 is the AT+CRMP command signal, when the AT+CRMP command signal is received, the AG 200 rings.

Thus, in a Bluetooth® hands-free and a mobile communication terminal according to the present invention, which are configured as described above, a user can control the mobile communication terminal to ring using the Bluetooth® hands-free. Hence, when the user loses the mobile communication terminal, the user can conveniently find the lost mobile communication terminal.

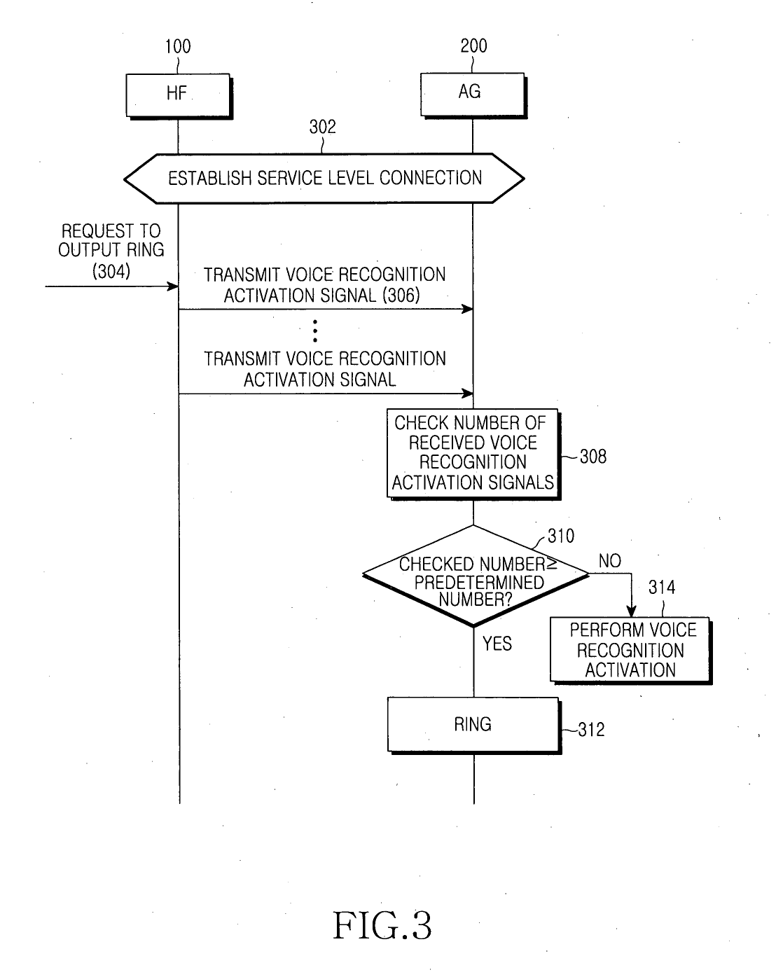

FIG. 3 is a diagram of a ring control process of a mobile communication terminal (the AG 200) using Bluetooth® communication according to a first embodiment of the present invention.

Referring to FIG. 3, the HF 100 and the AG 200 establish a service level connection for Bluetooth® communication in step 302. After establishing the service level connection, the HF 100 determines in step 304 whether the ring output request key is pressed by the user. The pressing of the ring output request key can be effectuated by pressing a separate key for requesting to output ring or by pressing the voice recognition activation key more than a set amount of times.

If it is determined that the ring output request key is pressed by the user, in step 306, the HF 100 transmits a voice recognition activation signal to the AG 200 more than a set amount of times or as many times as the number of pressing times of the voice recognition activation key by the user. In this case, the ring output request key may be pressed by the user before the service level connection is established. If so, the HF 100 transmits the voice recognition activation signal to the AG 200 after the service level connection is established between the HF 100 and the AG 200.

If the voice recognition activation signal is received from the HF 100, the AG 200 determines the number of received voice recognition activation signals in step 308. The AG 200 determines in step 310 whether the number of received voice recognition activation signals is greater than a set number.

If it is determined that the number of received voice recognition activation signals is greater than the set number, the AG 200 rings in step 312.

If it is determined that the number of received voice recognition activation signals is less than or equal to the set number, the AG 200 performs voice recognition activation in step 314. In this case, the AG 200 may determine that an error has occurred and may transmit an error signal to the HF 100.

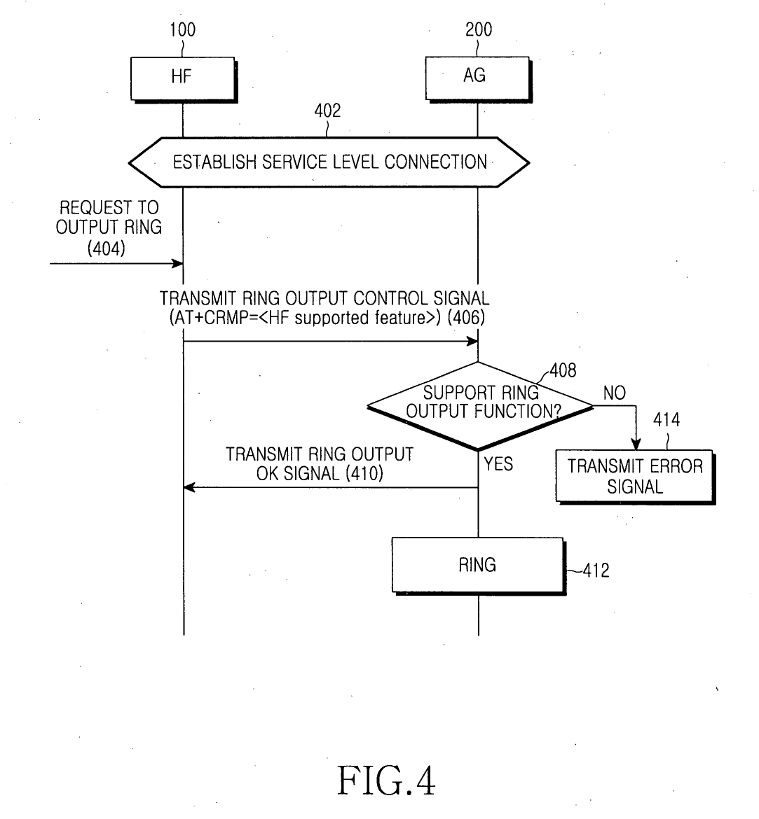

FIG. 4 is a signaling diagram of a ring control process of a mobile communication terminal (the AG 200) having a Bluetooth® communication according to a second embodiment of the present invention.

Referring to FIG. 4, the HF 100 and the AG 200 establish a service level connection for Bluetooth® communication in step 402. After establishing the service level connection, the HF 100 determines in step 404 whether the ring output request key is pressed by the user.

If it is determined that the ring output request key is pressed by the user, in step 406, the HF 100 transmits a ring output control signal to the AG 200 using an AT+CRMP command. In this case, the ring output request key may be pressed by the user before the service level connection is established. If it is determined that the ring output request key is pressed by the user before the service level connection is established, the HF 100 transmits the ring output control signal to the AG 200 after the service level connection is established between the HF 100 and the AG 200.

If the AT+CRMP command is received from the HF 100, the AG 200 determines in step 408 whether a ring output function according to the AT+CRMP command is supported.

If it is determined that the ring output function according to the AT+CRMP command is supported, the AG 200 transmits a ring output OK signal to the HF 100 in step 410 and rings in step 412.

If it is determined that the ring output function according to the AT+CRMP command is not supported, the AG 200 transmits an error signal to the HF 100 in step 414.

As described above, according to the present invention, since a mobile communication terminal can be controlled to ring using Bluetooth® communication, the user can conveniently find the lost mobile communication terminal.

In addition, by controlling a mobile communication terminal to ring using an existing command used between a Bluetooth® device and the mobile communication terminal, an additional command for controlling the mobile communication terminal to ring is not required.

While the invention has been shown and described with reference to a certain preferred embodiment thereof, it will be understood by those skilled in the art that various changes in form and details may be made therein without departing from the spirit and scope of the invention. For example, although the sound is a ring in the embodiments of the present invention, other sounds, such as music, stored in a mobile communication terminal can be used. In addition, although a sound output control of a mobile communication terminal is performed using Bluetooth® communication in the embodiments of the present invention, the sound output control of a mobile communication terminal can be performed using other communication, such as ultra wideband (UWB) or wireless local area network (WLAN). Thus, it will be understood by those skilled in the art that various changes in form and details may be made therein without departing from the spirit and scope of the invention as defined by the appended claims.

what is claimed is:

1. A mobile communication terminal, comprising:
a Bluetooth®-type module for receiving a command signal for requesting to output a sound stored in the mobile communication terminal from an external Bluetooth®-type device; and
a sound output unit for outputting the sound if the command signal for requesting to output the sound is received.

2. The mobile communication terminal of claim 1, wherein the command signal for requesting to output the sound indicates voice recognition activation signals transmitted more than a set amount of times.

3. The mobile communication terminal of claim 2, wherein if the voice recognition activation signal is received more than the set amount of times, the mobile communication terminal determines that the command signal for requesting to output the sound is received.

4. The mobile communication terminal of claim 1, wherein the command signal for requesting to output the sound indicates an AT+CRMP command.

5. The mobile communication terminal of claim 4, wherein if the AT+CRMP is received, the mobile communication terminal determines that the command signal for requesting to output the sound is received.

6. The mobile communication terminal of claim 1, wherein the external Bluetooth®-type device is either a Bluetooth®-type hands-free device or a Bluetooth®-type ear-microphone.

7. The mobile communication terminal of claim 1, wherein the sound is either a ring or music.

8. A Bluetooth®-type device, comprising:
a key input unit having a key for requesting to output a sound of a mobile communication terminal; and
a Bluetooth®-type module for transmitting a command signal for requesting to output the sound of the mobile communication terminal if the key for requesting to output the sound is pressed by a user.

9. The Bluetooth®-type device of claim 8, wherein the command signal for requesting to output the sound indicates voice recognition activation signals transmitted more than a set amount of times.

10. The Bluetooth®-type device of claim 8, wherein the command signal for requesting to output the sound indicates an AT+CRMP command.

11. The Bluetooth®-type device of claim 8, wherein the external Bluetooth®-type device is either a Bluetooth®-type hands-free device or a Bluetooth®-type ear-microphone.

12. The Bluetooth®-type device of claim 8, wherein the sound is either a ring or music.

13. A sound output control method of a mobile communication terminal, the method comprising the steps of:
receiving a command signal for requesting to output a sound stored in the mobile communication terminal from an external Bluetooth®-type device; and
outputting the sound if the command signal for requesting to output the sound is received.

14. The method of claim 13, wherein the command signal for requesting to output the sound indicates voice recognition activation signals transmitted more than a set amount of times.

15. The method of claim 14, wherein outputting the sound further comprises:
determining whether the voice recognition activation signal is received more than the set amount of times;
if it is determined that the voice recognition activation signal is received more than the set amount of times, determining that the command signal for requesting to output the sound is received; and
outputting the sound as the determination result.

16. The method of claim 13, wherein the command signal for requesting to output the sound indicates an AT+CRMP command.

17. The method of claim 16, wherein outputting the sound further comprises:
determining, if the AT+CRMP command is received, whether a sound output control function according to the AT+CRMP command is supported;
transmitting an error signal, if it is determined that the sound output control function according to the AT+CRMP command is not supported; and
outputting the sound, if it is determined that the sound output control function according to the AT+CRMP command is supported.

18. The method of claim 13, wherein the external Bluetooth®-type device is either a Bluetooth®-type hands-free or a Bluetooth®-type ear-microphone.

19. The method of claim 13, wherein the sound is either a ring or music.
